(19) United States
(12) Patent Application Publication
(10) Pub. No.: US 2024/0207972 A1
(43) Pub. Date: Jun. 27, 2024

(54) LASER PROCESSING DEVICE

(71) Applicant: Fulian Yuzhan Precision Technology Co., Ltd., Shenzhen (CN)

(72) Inventors: LIAO-YUAN LIANG, Shenzhen (CN); YOU-WEI HUANG, Shenzhen (CN); CHANG YANG, Shenzhen (CN); HAI-BO TANG, Shenzhen (CN); YONG CHENG, Shenzhen (CN)

(21) Appl. No.: 18/544,809

(22) Filed: Dec. 19, 2023

(30) Foreign Application Priority Data
Dec. 21, 2022 (CN) 202211652021.2

(51) Int. Cl. B23K 26/06; B23K 26/082

(52) U.S. Cl. CPC B23K 26/0648; B23K 26/0643; B23K 26/082

(57) ABSTRACT

A laser processing device includes a laser source, a zoom assembly for converging a laser light emitted by the laser source, a scanning galvanometer assembly for receiving the converged laser light exiting from the zoom assembly and emitting the laser light at a preset angle, and a reflection assembly arranged between the scanning galvanometer assembly and a workpiece. The zoom assembly includes a plurality of lens groups, the reflection assembly includes a plurality of reflectors for reflecting the laser light emitted by the scanning galvanometer assembly to the workpiece. A distance between any two lens groups of the plurality of lens groups is adjustable to adjust a position of a principle plane of the zoom assembly, thereby adjusting a focus position reflected to the workpiece.

### CROSS-REFERENCE TO RELATED APPLICATIONS

This application claims all benefits accruing under 35 U.S.C. § 119 from Chinese Patent Application No. 202211652021.2 filed on Dec. 21, 2022 in the State Intellectual Property Office of China, the entire contents of which are incorporated herein by reference.

### FIELD

The present disclosure relates to a technical field of laser processing, and more particularly, the present disclosure relates to a laser processing device.

### BACKGROUND

In production, it is often necessary to use laser to perform welding, marking, cutting, surface treatment, or other processing operations on workpieces. When processing a side wall with an angle of less than or equal to 90° between the side wall and a bottom wall connected to the side wall, the laser cannot achieve precise processing through a polarization of the galvanometer, resulting in repeated or missed processing on the side wall.

### SUMMARY

In view of the above situation, it is necessary to provide a laser processing device to reduce the phenomenon of repeatedly processing and process of omission when performing a surface treatment on a side wall of a workpiece and an angle between the side wall and a bottom wall of the workpiece connected to the side wall is less than or equal to 90°.

According to some embodiments, a laser processing device includes a laser source, a zoom assembly for converging a laser light emitted by the laser source, a scanning galvanometer assembly for receiving the converged laser light exiting from the zoom assembly and emitting the laser light at a preset angle, and a reflection assembly arranged between the scanning galvanometer assembly and the workpiece. The zoom assembly includes a plurality of lens groups, the reflection assembly includes a plurality of reflectors for reflecting the laser light emitted by the scanning galvanometer assembly to the workpiece to change a direction of the laser light to process the workpiece. A distance between any two lens groups of the plurality of lens groups is adjustable to adjust a position of a principle plane of the zoom assembly, thereby adjusting a focus position reflected to the workpiece.

When the above laser processing device is in use, the laser light emitted by the laser source is converged by the zoom assembly to and enters the galvanometer assembly from the zoom assembly in the form of a converging beam, then the direction of the laser light is changed by the scanning galvanometer assembly, so that the laser light exits at a preset angle from the galvanometer assembly to the reflection assembly, and is finally reflected by the plurality of reflectors to an inner side wall of the workpiece to process the workpiece. Since a focused spot of the laser light reflected on the inner side wall of the workpiece will change with a height difference of the inner side wall of the workpiece, the distance between any two lens groups of the plurality of lens groups needs to be adjusted to adjust the position of the principle plane of the zoom assembly, thereby adjusting the position of the focused spot reflected to the workpiece, so that the laser light on the inner side wall of the workpiece can maintain a focused state as the height difference of the inner side wall of the workpiece, thereby improving the uniformity of the focused spot and preventing insufficient uniformity of the surface treatment on the inner side wall of the workpiece due to sharp changes in the size of the focused spot. As a result, the processing quality can be improved.

According to some embodiments, the plurality of reflectors are arranged in a ring shape.

According to some embodiments, the plurality of reflectors are arranged at equal intervals.

According to some embodiments, each of the plurality of reflectors is arranged obliquely.

According to some embodiments, the reflection assembly further includes a plurality of driving members, each of the plurality of driving members is connected to one of the plurality of reflectors for driving the connected reflector of the plurality of reflectors to rotate.

According to some embodiments, an angle of reflection of the laser light reflected by each of the plurality of reflectors is in a range of 30° to 65° when each of the plurality of reflectors is driven by the connected driving member of the plurality of driving members.

According to some embodiments, at least one metal film and/or at least one dielectric film are arranged on each of the plurality of reflectors.

According to some embodiments, at least one metal film includes silver, and/or the at least one dielectric film includes calcium fluoride.

According to some embodiments, along an emission direction of the laser light emitted by the laser source, the zoom assembly includes a beam expander lens group, a collimating and focusing lens group, and a focusing lens group in that sequence. The beam expander lens group is configured to expand the laser light emitted by the laser source, the collimating and focusing lens group is configured to collimate and converge the expanded laser light, and the focusing lens group is configured to perform a secondary convergence on the collimated and primary converged laser light. The collimating and focusing lens group and the focusing lens group are movable relative to the beam expander lens group to adjust the position of the principle plane of the zoom assembly.

According to some embodiments, the collimating and focusing lens group includes a convex lens for collimating the expanded laser light and a crescent lens for correcting a divergence angle of the collimated laser light to converge the collimated laser light.

According to some embodiments, the beam expander lens group includes a crescent lens for expanding the laser light emitted by the laser source.

According to some embodiments, the crescent lens of the beam expander lens group is made of fused silica material.

According to some embodiments, the beam expander lens group is a variable zoom beam expander with a zoom range of 1.5 times to 10 times or a fixed zoom beam expander.

According to some embodiments, the focusing lens group includes a convex lens for converging the laser light again after the collimation and the primary convergence.

According to some embodiments, a beam waist of the converged laser light exiting from the zoom assembly is in a range of 42 μm to 49 μm.

According to some embodiments, two metal films and two dielectric films are arranged on each of the plurality of reflectors.

According to some embodiments, three dielectric films or three metal films arranged on each of the plurality of reflectors.

### BRIEF DESCRIPTION OF THE DRAWINGS

Implementations of the present disclosure will now be described, by way of example only, with reference to the attached figures.

FIG. 1 is a diagram of an embodiment of a laser processing device according to the present disclosure.

FIG. 2 is a plan view of the laser processing device of FIG. 1.

FIG. 3 is a diagram of an embodiment of a laser processing device processing a workpiece according to the present disclosure.

FIG. 4 is a diagram of another embodiment of a laser processing device processing a workpiece according to the present disclosure.

FIG. 5 is a diagram of another embodiment of a laser processing device processing a workpiece according to the present disclosure.

FIG. 6 is a diagram of an embodiment of an optical path of a laser processing device according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

In the related art, when performing surface treatment on a side wall of a workpiece and an angle between the side wall and a bottom wall connected to the side wall is less than or equal to 90°, it is necessary to use a multi-axis moving mechanism to drive the workpiece to move multiple times so that the laser can perform surface treatment on the side wall of the workpiece. Due to an accuracy of the multi-axis moving mechanism, some areas on the side wall of the workpiece may be repeatedly processed or omitted to be processed, which affects the processing effect. Moreover, since the multi-axis moving mechanism is required to drive the workpiece to move multiple times, the processing time and manufacturing cost will be increased.

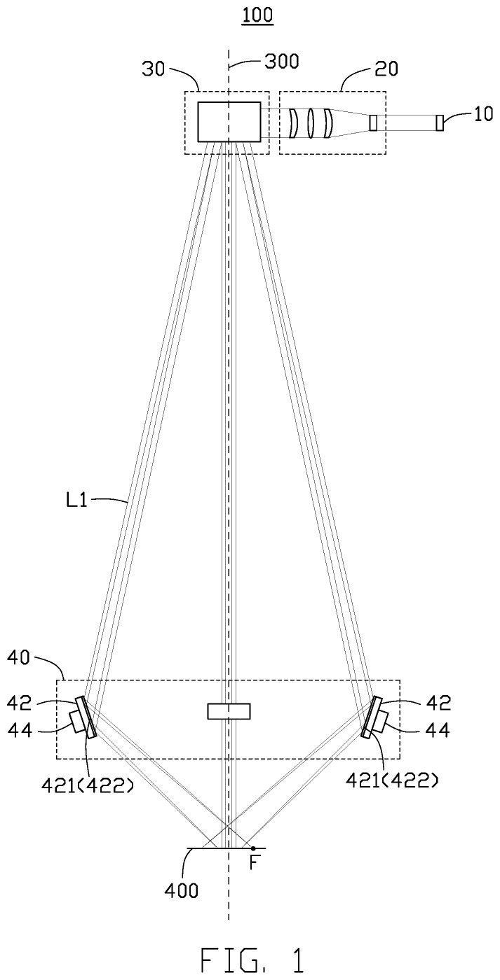

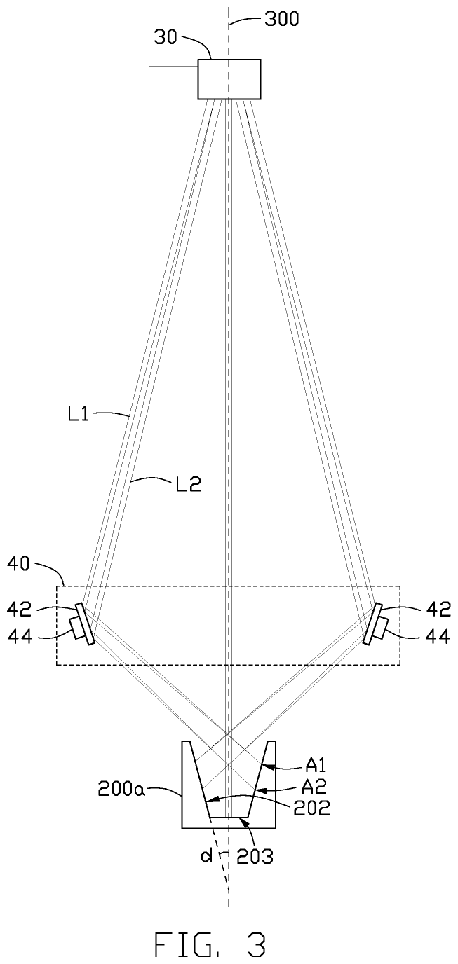

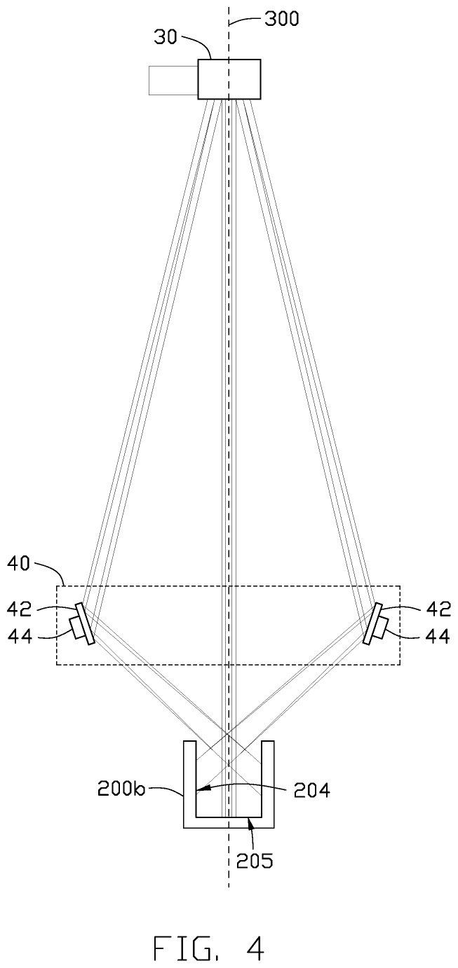

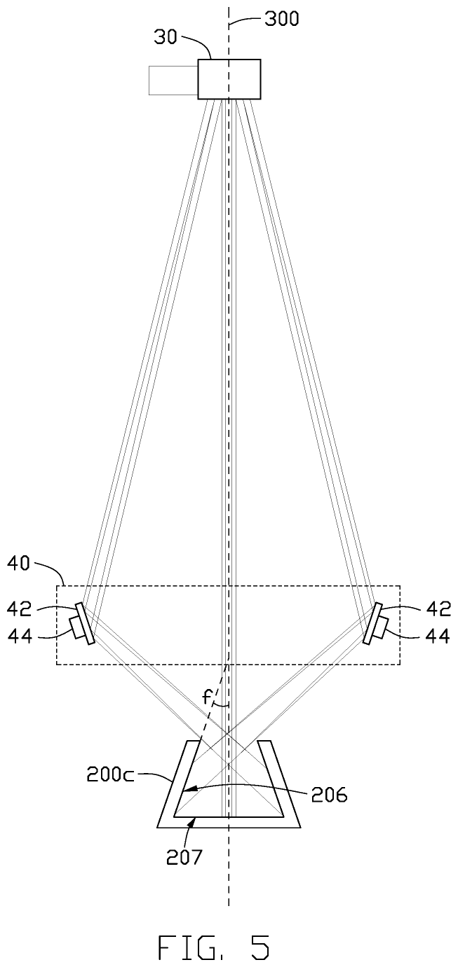

Referring to FIG. 1, in some embodiments illustrated in FIG. 1, a laser processing device 100 used to process workpieces is provided. Each of the workpieces may have a three-dimensional structure, such as a wide-mouthed workpiece 200a shown in FIG. 3, a cylindrical workpiece 200b shown in FIG. 4, or a narrow-mouthed workpiece 200c shown in FIG. 5. In some embodiments, the workpieces may be cubic, spherical or other shaped objects.

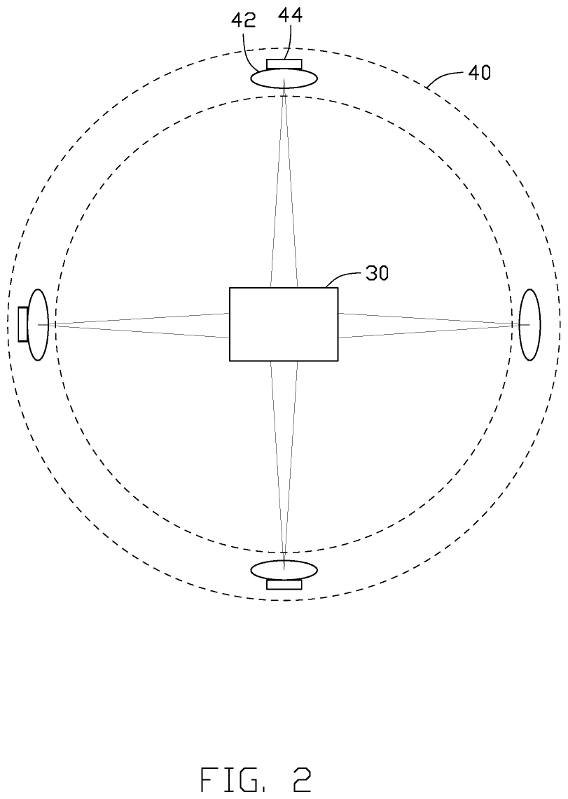

Referring to FIG. 1 and FIG. 2, the laser processing device 100 includes a laser source 10, a zoom assembly 20, a scanning galvanometer assembly 30, and a reflection assembly 40.

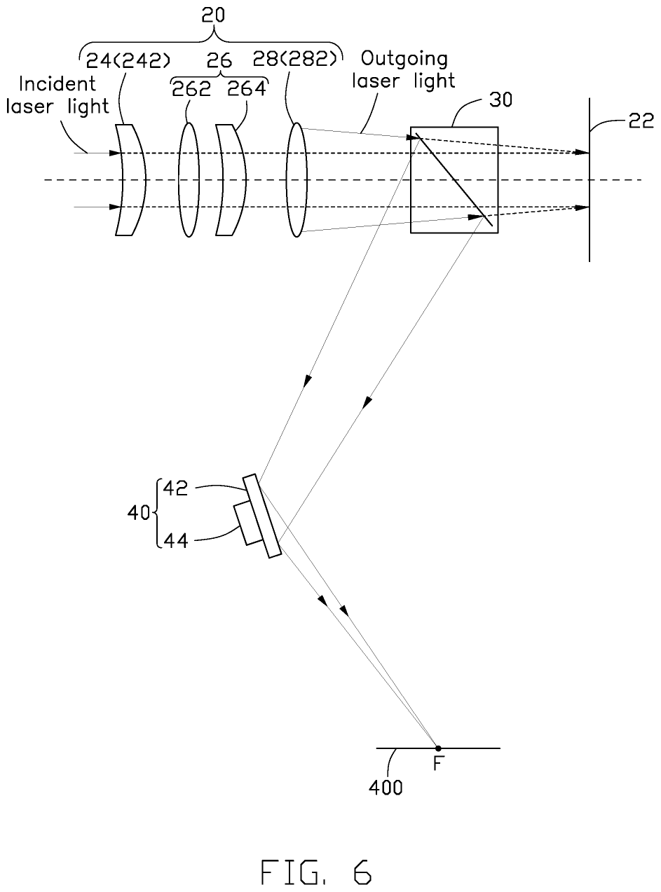

The laser source 10 is used to emit laser light L1. The zoom assembly 20 includes a plurality of lens groups for converging the laser light L1 emitted by the laser source 10, and the laser light L1 exits from the zoom assembly 20 in a form of a converged beam. The scanning galvanometer assembly 30 is used to receive the laser light L1 exiting from the zoom assembly 20 and emit laser light L1 at a preset angle. The reflection assembly 40 is arranged between the scanning galvanometer assembly 30 and the workpiece. The reflection assembly 40 includes a plurality of reflectors 42 for reflecting the laser light L1 emitted by the scanning galvanometer assembly 30 to the workpiece, and the workpiece is processed by adjusting a direction of the laser light L1 reflected to the workpiece. A distance between any two lens groups of the plurality of lens groups can be adjusted, thereby adjusting a position of a principle plane 22 (shown FIG. 6) of the zoom assembly 20 to adjust a focus position reflected to the workpiece. Referring to FIG. 1, the laser light L1 is finally reflected by the reflection assembly 40 onto a focal plane 400 and a focus point F of the laser light L1 after being reflected is focused at a point F on the focal plane 400, the focal plane 400 is perpendicular to an optical axis 300 of the scanning galvanometer assembly 30.

When the laser processing device 100 is in use, the laser source 10 emits laser light L1 to the zoom assembly 20, the laser light L1 is converged by the zoom assembly 20 and enters the scanning galvanometer assembly 30 from the zoom assembly 20 in the form of a converging beam, then the direction of the laser light L1 is changed by the scanning galvanometer assembly 30, so that the laser light L1 exits at a preset angle from the scanning galvanometer assembly 30 to the plurality of reflectors 42 of the reflection assembly 40, and is finally reflected by the plurality of reflectors 42 to an inner side wall of the workpiece to process the workpiece. At the same time, the laser light L1 is focused on the inner side wall of the workpiece in a convergent manner, and the laser processing of the inner side wall of the workpiece is realized by changing the direction of the laser light L1. Since the workpiece has a three-dimensional structure such as shown in FIG. 3, FIG. 4, and FIG. 5, the focused spot of the laser light L1 reflected on the inner side wall of the workpiece will change with a height difference of the inner side wall of the workpiece, specifically, a size of the focused spot will change, thereby affecting the processing quality. In order to solve the above-mentioned problem, the distance between any two lens groups of the plurality of lens groups can be adjusted to adjust the position of the principle plane 22 (shown FIG. 6) of the zoom assembly 20, thereby adjusting the focus position reflected to the workpiece, so that the laser light L1 on the inner side wall of the workpiece can maintain a focused state as the height difference of the inner side wall of the workpiece, specifically, the rate of change in the size of the focused spot meets the requirements, thereby improving the uniformity of the focused spot and preventing insufficient uniformity of the surface treatment on the inner side wall of the workpiece due to sharp changes in the size of the focused spot. As a result, the phenomenon of some areas on the side wall of the workpiece repeatedly processed or omitted to be processed is reduced, and the processing quality can be improved.

In different application scenarios, different laser output powers can be selected for the laser source 10.

According to some embodiments, the plurality of reflectors 42 may be evenly arranged in a ring shape, furthermore, the plurality of reflectors 42 may be arranged at equal intervals, so that the laser light L1 reflected through the plurality of reflectors 42 can be incident on inner side wall of the workpiece in multiple directions or even in all directions to perform an all-round and full-coverage laser process on the inner side wall of the workpiece. Each of the plurality of reflectors 42 may be arranged obliquely, so that a polarization effect of the plurality of reflectors 42 is small. In this embodiment, the number of the reflectors 42 may be four. When the plurality of reflectors 42 are evenly arranged, the laser light L1 may process the workpiece within 20 mm on the focal plane 400.

According to some embodiments, the number of the reflectors 42 may be more, such as six, eight, ten and so on. It should be understood that the greater the number of the reflectors 42, the more fineness of the laser process can be improved, but at the same time, controlling the movement of multiple reflectors 42 will be relatively more complicated, so that an appropriate number of the reflectors 42 may be selected after comprehensively evaluating the fineness of the laser process and the complexity of controlling the reflectors 42.

According to some embodiments, at least one metal film 421 and/or at least one dielectric film 422 may be arranged on each of the plurality of reflectors 42 to increase a reflectivity of each of the plurality of reflectors 42, thereby reducing an attenuation of the laser light L1 and improving the power of the laser light L1 during processing. In at least one embodiment, as an example, two metal films 421 and two dielectric films 422 are arranged on each of the plurality of reflectors 42. In some embodiments, as an example, three dielectric films 422 are arranged on each of the plurality of reflectors 42, or, three metal films 421 are arranged on each of the plurality of reflectors 42. Each of the at least one metal film 421 may include silver, and each of the at least one dielectric film 422 may include calcium fluoride.

According to some embodiments, the reflection assembly 40 may further include a plurality of driving members 44 connected to the plurality of reflectors 42 in one-to-one correspondence. Each of the plurality of driving members 44 is used to drive the corresponding reflector 42 to rotate or deflect, so as to increase an angle of reflection of the laser light L1 reflected by the reflector 42 to be in a range of 30° to 65°, so that the laser light L1 can be incident on the inner side wall of the workpiece at a preset angle of reflection. Furthermore, the angle of reflection of the laser light L1 reflected by the reflector 42 is in a range of 30° to 65°, which enables the reflectivity of the reflector 42 to be greater than or equal to 99%, thereby greatly improving the reflectivity of the reflector 42. In addition, the rotation and deflection of the reflector 42 driven by the driving member 44 cooperates with the scanning galvanometer assembly 30, which can further expand the angle at which the laser light L1 is incident on the inner side wall of the workpiece, so as to perform laser processing operations on the workpiece in all directions and with full coverage. It should be noted that the scanning galvanometer assembly 30 may drive an X-direction galvanometer lens and a Y-direction galvanometer lens to deflect through a voice coil motor, thereby deflecting a direction of the laser light L1. In the present disclosure, a relevant structure of the scanning galvanometer assembly 30 will not described in detail.

In at least embodiment, each driving member 44 may be a voice coil motor or other functional mechanism capable of driving the reflector 42 to rotate or deflect, such a motor or memory alloy.

In some embodiments illustrated in FIGS. 3, the laser processing device 100 is used to process the wide-mouthed workpiece 200a. An inner side wall 202 and a bottom wall 203 of the workpiece 200a form an outwardly expanding structure (that is, an angle between the inner side wall 202 and the bottom wall 203 is an obtuse angle), and an included angle between the inner side wall 202 and the optical axis 300 of the scanning galvanometer assembly 30 is defined as d, d is equal to 10° or less than 10°. The laser light L1 is incident on the inner side wall 202 of the workpiece 200a after passing through the zoom assembly 20, the scanning galvanometer assembly 30, and the reflection assembly 40. An incident direction of the laser light L1 can be changed through the scanning galvanometer assembly 30 and the rotation of the reflectors 42 driven by the driving members 44, and with the cooperation of the zoom assembly 20, the laser light L1 can be incident on any position of the inner side wall 202 of the workpiece 200a and the laser light L1 can maintain a focused state at any position of the inner side wall 202 of the workpiece 200a, so that an all-round and full-coverage laser process can be effectively performed on the inner side wall 202 of the workpiece 200a. Ordinary laser processing devices only having a focusing system and a scanning galvanometer system cannot process workpieces with the included angle d between the inner side wall 202 and the optical axis 300 less than or equal to 10°. It should be noted that, when the included angle d between the inner side wall 202 and the optical axis 300 is greater than 10°, the laser processing device 100 provided by the present disclosure can also realize laser processing on the workpiece 200a.

In some embodiments illustrated in FIG. 4, the laser processing device 100 is used to process the cylindrical workpiece 200b. An inner side wall 204 and a bottom wall 205 of the workpiece 200b define a similar cylindrical space (that is, an angle between the inner side wall 204 and the bottom wall 205 is about 90°), and the inner side wall 204 is parallel to the optical axis 300. The laser light L1 is incident on the inner side wall 204 of the workpiece 200b after passing through the zoom assembly 20, the scanning galvanometer assembly 30, and the reflection assembly 40. An incident direction of the laser light L1 can be changed through the scanning galvanometer assembly 30 and the rotation of the reflectors 42 driven by the driving members 44, and with the cooperation of the zoom assembly 20, the laser light L1 can be incident on any position of the inner side wall 204 of the workpiece 200b and the laser light L1 can maintain a focused state at any position of the inner side wall 204 of the workpiece 200b, so that an all-round and full-coverage laser process can be effectively performed on the inner side wall 204 of the workpiece 200b.

In some embodiments illustrated in FIG. 5, the laser processing device 100 is used to process the narrow-mouthed workpiece 200c. A cross-section of a structure formed by an inner side wall 206 and a bottom wall 207 of the workpiece 200c is similar to a dovetail groove (that is, an angle between the inner side wall 206 and the bottom wall 207 is an acute angle), and an included angle between the inner side wall 206 and the optical axis 300 is defined as f, f may be 30° or any other angle greater than 0° and less than 90°. The laser light L1 is incident on the inner side wall 206 of the workpiece 200c after passing through the zoom assembly 20, the scanning galvanometer assembly 30, and the reflection assembly 40. An incident direction of the laser light L1 can be changed through the scanning galvanometer assembly 30 and the rotation of the reflectors 42 driven by the driving members 44, and with the cooperation of the zoom assembly 20, the laser light L1 can be incident on any position of the inner side wall 206 of the workpiece 200c and the laser light L1 can maintain a focused state at any position of the inner side wall 206 of the workpiece 200c, so that an all-round and full-coverage laser process can be effectively performed on the inner side wall 206 of the workpiece 200c. In at least one embodiment, the inner side wall 206 of the narrow-mouthed workpiece 200c may be a curved surface concave toward a direction away from optical axis 300, and the laser processing device 100 provided by the present disclosure can also realize laser processing on the narrow-mouthed workpiece 200c whose the inner side wall 206 is a concave curved surface.

In some embodiments illustrated in FIG. 6, along an emission direction of the laser light L1 emitted from the laser source 10, the zoom assembly 20 may include a beam expander lens group 24, a collimating and focusing lens group 26, and a focusing lens group 28 in that sequence.

The beam expander lens group 24 is used to expand the laser light L1 emitted from the laser source 10. The collimating and focusing lens group 26 is used for collimating and converging the expanded laser light. The focusing lens group 28 is used for performing a secondary convergence on the collimated and primary converged laser light, so that the laser light L1 can be emitted in a form of converged light finally. The collimating and focusing lens group 26 and the focusing lens group 28 can move relative to the beam expander lens group 24 to adjust the position of the principle plane 22 of the zoom assembly 20. The principle plane 22 is formed by an intersection of an extension lines of an incident laser light and an outgoing light. When the position of the principle plane 22 changes, the focus position F will also change.

In the related art, the principle point and the principle plane are special terms in ideal optical systems. The principle points are a pair of conjugate points with constant transversal magnification in the conjugate space of an optical system. A surface perpendicular to the optical axis and formed by combining these conjugate points is defined as the principle plane. The principle plane is a virtual surface for the convenience of describing the optical system formed by multiple lens groups. In the optical system, the great advantage brought by the introduction of the concept of the principle plane is that after an actual optical system is replaced by an equivalent ideal optical system, the multiple refraction and reflection of the actual system can be replaced by one deflection in a direction of the conjugate light at the principle plane.

In this way, the position of the principle plane 22 of the zoom assembly 20 can be adjusted by moving the collimating and focusing lens group 26 and the focusing lens group 28, so that the laser light L1 incident on the inner side wall of the workpiece remains in a focused state without changing an effective focal length of the laser light L1 in a large range, and the laser light L1 can achieve the effect of diffraction limit at different positions on the inner side wall of the workpiece. By changing the position of the principle plane 22 of the zoom assembly 20, a working distance of the laser processing device 100 is increased, the variation range of the effective focal length is reduced, so that a rate of change in a size of the focused spot is reduced, and the uniformity of the focused spot is improved, thereby improving the uniformity of the laser processing. When a movement range of the position of the principle plane 22 of the zoom assembly 20 is less than 5 mm, the laser processing device 100 can achieve a zoom distance greater than or equal to 120 mm.

According to some embodiments, the position of the principle plane 22 of the zoom assembly 20 is located on a side of the scanning galvanometer assembly 30 away from the zoom assembly 20, so as to focus the laser light L1 on the workpiece after passing through the canning galvanometer assembly 30 and the reflection assembly 40.

According to some embodiments, the collimating and focusing lens group 26 and the focusing lens group 28 may be respectively driven through voice coil motors.

According to some embodiments, along the emission direction of the laser light L1 emitted from the laser source 10, the collimating and focusing lens group 26 may include a first lens 262 and a second lens 264. The first lens 262 is used for collimating the expanded laser light, and the first lens 262 is a convex lens. The second lens 264 is used to correct a divergence angle of the collimated laser light to converge the collimated laser light, and the second lens 264 is a crescent lens.

The beam expander lens group 24 includes a third lens 242 for expanding the laser light emitted from the laser source 10, and the third lens 242 is a crescent lens. The third lens 242 may be a lens made of fused silica material to meet power applications from 10 W to 20000 W. In at least one embodiment, the beam expander lens group 24 may be a fixed zoom beam expander or a variable zoom beam expander with a zoom range of 1.5 times to 10 times.

The focusing lens group 28 includes a fourth lens 282 for converging the laser light L1 again after the collimation and the primary convergence, and the fourth lens 282 is a convex lens.

According to some embodiments, a beam waist of the converged laser light emitted from the zoom assembly 20 may be in a range of 42 μm to 49 μm, so that the rate of change in the size of the focused spot of the laser light L1 is less than 15%, thereby preventing insufficient uniformity surface treatment of the workpiece due to sharp changes in the size of the focused spot.

In at least one embodiment, through a cooperation between the zoom assembly 20, the canning galvanometer assembly 30, and the reflection assembly 40, the position of the principle plane 22 of the zoom assembly 20 can be adjusted, and a position of the focus point F of the laser light L1 can be adjusted, so that the laser light L1 is always focused on the inner side wall of the workpiece in the convergent manner, thereby enabling more precise laser processing of the inner side wall of the workpiece. In at least one embodiment, referring to FIGS. 3 and 6, when the laser processing device 100 processes a wide-mouthed workpiece 200a shown in FIG. 3, the laser light L1 is incident on the inner side wall 202 of the workpiece 200a after passing through the beam expander lens group 24, the collimating and focusing lens group 26, the focusing lens group 28, the scanning galvanometer assembly 30, and the reflection assembly 40 in sequence, and a position A1 of the focus point of the laser light L1 is located on the inner side wall 202 of the workpiece 200a. When processing the inner side wall 202 of the workpiece 200a from the position A1 toward the bottom wall 203, the incident laser light can remain unchanged, positions of the reflectors 40, the beam expander lens group 24, and the focusing lens group 28 can remain unchanged, and then the collimating and focusing lens group 26 is moved in a direction away from the beam expander lens group 24 to adjust the principle plane 22 of the zoom assembly 20, so that the principle plane 22 is moved away from the beam expander lens group 24. At the same time, an angle of the scanning galvanometer assembly 30 is adjusted by shifting the scanning galvanometer assembly 30 in a counterclockwise direction. Through the above adjustments, on the premise that the incident laser light remains unchanged, the outgoing light can be changed from a laser beam L1 to a laser beam L2 by adjusting the collimating and focusing lens group 26 and the scanning galvanometer assembly 30. The laser beam L2 is reflected by the reflector 42 and then is incident on the inner side wall 202 of the workpiece 200a, and a position A2 of a focus point of the laser beam L2 is located on the inner side wall 202. That is, by cooperatively adjusting the collimating and focusing lens group 26 and the scanning galvanometer assembly 30, the position of the focus point of the laser light is adjusted so that the focus point of the laser light can always be located on the inner side wall 202 of the workpiece 200a.

In actual laser processing operations, the adjustment path and angle of the collimating and focusing lens group 26 and the scanning galvanometer assembly 30 can be set according to the processing path of the inner side wall of the workpiece, so that the focus point F of the laser light L1 can be always be located on the inner side wall of the workpiece.

In the above-mentioned laser processing device 100, through the cooperation between the zoom assembly 20, the scanning galvanometer assembly 30, and the reflection assembly 40, the laser processing device 100 can realize multi-angle and full coverage of the workpiece so as to perform laser light L1 on the inner side wall of the workpiece for processing. Compared with the related art, the workpiece does not need to be driven by the multi-axis moving mechanism to move multiple times, which reduces laser splicing errors caused by the accuracy of the multi-axis moving mechanism, thereby reducing the phenomenon of repeatedly processing and process of omission. Since the workpiece does not need to be driven by the multi-axis moving mechanism to move multiple times, and the laser has the characteristics of fast response, the processing time can be effectively shortened and the manufacturing cost can be reduced. In addition, the position of the principle plane 22 of the zoom assembly 20 can be adjusted by adjusting distance between any two lens groups of the plurality of lens groups, and the focus position F can also be adjusted with the adjustment of the position of the principle plane 22, so that the laser light L1 can maintain a focused state with the height difference of the inner side wall of the workpiece, and the rate of change in the size of the focused spot meets the requirements, which is conducive to improving uniformity of the focused spot and preventing insufficient uniformity of the surface treatment on the inner side wall of the workpiece due to sharp changes in the size of the focused spot. As a result, the processing quality can be improved.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A laser processing device for processing a workpiece, comprising:
a laser source;
a zoom assembly comprising a plurality of lens groups for converging a laser light emitted by the laser source;
a scanning galvanometer assembly for receiving the converged laser light exiting from the zoom assembly and emitting the laser light at a preset angle; and
a reflection assembly arranged between the scanning galvanometer assembly and the workpiece, the reflection assembly comprising a plurality of reflectors for reflecting the laser light emitted by the scanning galvanometer assembly to the workpiece to change a direction of the laser light to process the workpiece;
wherein a distance between any two lens groups of the plurality of lens groups is adjustable to adjust a position of a principle plane of the zoom assembly, thereby adjusting a focus position reflected to the workpiece.

2. The laser processing device of claim 1, wherein the plurality of reflectors are arranged in a ring shape.

3. The laser processing device of claim 2, wherein the plurality of reflectors are arranged at equal intervals.

4. The laser processing device of claim 3, wherein each of the plurality of reflectors is arranged obliquely.

5. The laser processing device of claim 2, wherein the reflection assembly further comprises a plurality of driving members, each of the plurality of driving members is connected to one of the plurality of reflectors for driving the connected reflector of the plurality of reflectors to rotate.

6. The laser processing device of claim 5, wherein an angle of reflection of the laser light reflected by each of the plurality of reflectors is in a range of 30° to 65° when each of the plurality of reflectors is driven by the connected driving member of the plurality of driving members.

7. The laser processing device of claim 1, wherein at least one metal film and/or at least one dielectric film are arranged on each of the plurality of reflectors.

8. The laser processing device of claim 7, wherein the at least one metal film comprises silver, and/or the at least one dielectric film comprises calcium fluoride.

9. The laser processing device of claim 1, wherein along an emission direction of the laser light emitted by the laser source, the zoom assembly comprises a beam expander lens group, a collimating and focusing lens group, and a focusing lens group in that sequence;
the beam expander lens group is configured to expand the laser light emitted by the laser source, the collimating and focusing lens group is configured to collimate and converge the expanded laser light, and the focusing lens group is configured to perform a secondary convergence on the collimated and primary converged laser light, the collimating and focusing lens group and the focusing lens group are movable relative to the beam expander lens group to adjust the position of the principle plane of the zoom assembly.

10. The laser processing device of claim 9, wherein the collimating and focusing lens group comprises:
a convex lens for collimating the expanded laser light; and
a crescent lens for correcting a divergence angle of the collimated laser light to converge the collimated laser light.

11. The laser processing device of claim 9, wherein the beam expander lens group comprises a crescent lens for expanding the laser light emitted by the laser source.

12. The laser processing device of claim 11, wherein the crescent lens of the beam expander lens group is made of fused silica material.

13. The laser processing device of claim 11, wherein the beam expander lens group is a variable zoom beam expander with a zoom range of 1.5 times to 10 times or a fixed zoom beam expander.

14. The laser processing device of claim 9, wherein the focusing lens group comprises a convex lens for converging the laser light again after the collimation and the primary convergence.

15. The laser processing device of claim 1, wherein a beam waist of the converged laser light exiting from the zoom assembly is in a range of 42 μm to 49 μm.

16. The laser processing device of claim 1, wherein two metal films and two dielectric films are arranged on each of the plurality of reflectors.

17. The laser processing device of claim 1, wherein three dielectric films or three metal films arranged on each of the plurality of reflectors.
